(19) United States
(12) Patent Application Publication
(10) Pub. No.: US 2024/0191074 A1
(43) Pub. Date: Jun. 13, 2024

(54) Flame-Retardant Modified-Poly (phenylene oxide) Resin Composition With Excellent Deformation Resistance And Mechanical Properties And Article Molded Therefrom

(71) Applicant: HANWHA TOTALENERGIES PETROCHEMICAL CO., LTD., Chungcheongnam-Do (KR)

(72) Inventors: Yong Ki HWANG, Chungcheongnam-do (KR); Taeyoung KIM, Chungcheongnam-do (KR); Jeong Gil KO, Chungcheongnam-do (KR)

(21) Appl. No.: 18/530,684

(22) Filed: Dec. 6, 2023

(30) Foreign Application Priority Data
Dec. 13, 2022 (KR) 10-2022-0173557

(51) Int. Cl. C08L 71/12

(52) U.S. Cl. CPC C08L 71/126; C08L 2201/02

(57) ABSTRACT

A flame-retardant modified-poly(phenylene oxide) resin composition and an article molded therefrom are provided. The flame-retardant modified-poly(phenylene oxide) resin composition provides a flame-retardant modified-poly(phenylene oxide) resin article that has excellent deformation resistance and mechanical properties, along with enhanced product moldability and appearance quality. Accordingly, the flame-retardant modified-poly(phenylene oxide) resin article can be advantageously used as a battery module housing for electric vehicles.

### CROSS REFERENCE TO RELATED APPLICATIONS

This application claims priority from Korean Patent Application No. 10-2022-0173557 filed on Dec. 13, 2022, the entire contents of which are hereby expressly incorporated by reference.

### BACKGROUND

### Technical Field

The present invention relates to a flame-retardant modified-poly(phenylene oxide) resin composition and to an article molded therefrom. Specifically, the present invention relates to a flame-retardant modified-poly(phenylene oxide) resin composition, which is excellent in deformation resistance and mechanical properties, and to an article molded therefrom.

### Related Art

Poly(phenylene oxide) (PPO) or poly(phenylene ether) (PPE), a type of engineering plastic, has excellent mechanical properties, electrical properties, thermal resistance, and dimensional stability, along with a low moisture absorption rate, it is widely used in automotive and electrical/electronic parts that require precise dimensions.

Since poly(phenylene oxide) has a high melt viscosity, thereby having poor moldability, it is rarely used alone. Rather, it is often mixed with polystyrene, which has good miscibility, to be used as a modified-poly(phenylene oxide) (mPPO) resin.

Meanwhile, due to the high performance and high functionality of electric vehicles and various electronic devices, the structure of products is becoming more complicated, and the demand for moldability and deformation stability is increasing due to continuous enhancement of flame-retardant performance. In addition, as the automated process of parts assembly continues to expand, the number of processes in which robots transport and assemble parts is increasing. Thus, the development of materials that can minimize deformation is required.

In general, modified-poly(phenylene oxide) (mPPO) resins are known to have excellent deformation resistance characteristics among thermoplastic resins and are applied to battery module housing parts of electric vehicles. Flame-retardant mPPO resins reinforced with glass fiber are used as a material for battery module housings of electric vehicles. Although deformation after injection is relatively stable as compared with other materials, there is a disadvantage in that the appearance quality of injection parts is significantly deteriorated. In addition, when an injection part has a long or complex structure, there would be a problem in that deformation occurs in the injection direction and the reverse direction.

Accordingly, there is a need for the development of a flame-retardant modified-poly(phenylene oxide) resin composition that has excellent deformation resistance and mechanical properties, along with enhanced product moldability and appearance quality.

### PRIOR ART DOCUMENTS

### Patent Documents

Patent Document 1: Korean Laid-open Patent Publication No. 10-2014-0131652
Patent Document 2: Korean Laid-open Patent Publication No. 10-2014-0131653
Patent Document 3: Korean Laid-open Patent Publication No. 10-2014-0131654
Patent Document 4: Korean Laid-open Patent Publication No. 10-2017-0019719

An object of the present invention is to provide a flame-retardant modified-poly(phenylene oxide) resin composition that has excellent deformation resistance and mechanical properties, along with enhanced product moldability and appearance quality.

Another object of the present invention is to provide an article prepared from the flame-retardant modified-poly(phenylene oxide) resin composition.

### SUMMARY

According to an embodiment of the present invention to accomplish the object, there is provided a flame-retardant modified-poly(phenylene oxide) resin composition, which comprises, based on the total weight of the composition, (A) 40 to 60% by weight of a poly(phenylene oxide) resin; (B) 10 to 30% by weight of a polystyrene-based resin; (C) 5 to 15% by weight of a flame retardant; (D) 2 to 8% by weight of a compatibilizer; (E) 5 to 15% by weight of a reinforcing agent; (F) 1 to 5% by weight of an impact modifier; and (G) 2 to 6% by weight of an additive.

In a specific embodiment of the present invention, the poly(phenylene oxide) resin (A) may comprise at least one selected from the group consisting of poly(2,6-dimethyl-1,4-phenylene)ether, poly(2,6-diethyl-1,4-phenylene)ether, poly(2,6-dipropyl-1,4-phenylene)ether, poly(2,6-dibutyl-1,4-phenylene)ether, poly(2,6-dirauryl-1,4-phenylene)ether, poly(2-methyl-6-ethyl-1,4-phenylene)ether, poly(2-methyl-6-propyl-1,4-phenylene)ether, poly(2-methyl-6-tolyl-1,4-phenylene)ether, poly(2-methyl-6-butyl-1,4-phenylene)ether, poly(2-ethyl-6-propyl-1,4-phenylene)ether, poly(2,6-diphenyl-1,4-phenylene)ether, poly(2,6-dimethoxy-1,4-phenylene)ether, poly(2,6-diethoxy-1,4-phenylene)ether, poly(2,3,6-trimethyl-1,4-phenylene)ether, copolymers of poly(2,6-dimethyl-1,4-phenylene)ether and poly(2,3,6-trimethyl-1,4-phenylene)ether, and copolymers of poly(2,6-dimethyl-1,4-phenylene)ether and poly(2,3,5,6-tetramethyl-1,4-phenylene)ether.

In a preferred embodiment of the present invention, the poly(phenylene oxide) resin (A) may comprise poly(2,6-dimethyl-1,4-phenylene)ether.

In a specific embodiment of the present invention, the poly(phenylene oxide) resin (A) may have an intrinsic viscosity of 0.3 to 0.6 dl/g when measured in a chloroform solvent at 25° C.

In a specific embodiment of the present invention, the polystyrene-based resin (B) may comprise at least one selected from the group consisting of a high-impact polystyrene resin (HIPS resin), an acrylonitrile-butadiene-styrene resin (ABS resin), an acrylonitrile-ethylene-propylene rubber-styrene resin (AES resin), and an acrylonitrile-acrylate-styrene resin (AAS resin).

In a preferred embodiment of the present invention, the polystyrene-based resin (B) may comprise a high-impact polystyrene resin (HIPS resin).

In a specific embodiment of the present invention, the flame retardant (C) is a phosphorus-based flame retardant and may comprise at least one selected from the group consisting of triphenylphosphate (TPP), bisphenol A bis(diphenylphosphate) (BDP), and aluminum diethylphosphinate (ADP).

In a specific embodiment of the present invention, the compatibilizer (D) may comprise a modified poly(phenylene oxide) resin grafted with maleic anhydride prepared by the reaction and extrusion of a poly(phenylene oxide) resin and maleic anhydride.

In a specific embodiment of the present invention, the reinforcing agent (E) may comprise at least one selected from the group consisting of silane-coated glass fiber and silane-coated glass beads.

In a specific embodiment of the present invention, the impact modifier (F) may comprise at least one selected from the group consisting of styrene-ethylene-butadiene-styrene (SEBS) rubber, styrene-ethylene-propylene-styrene (SEPS) rubber, styrene-ethylene-propylene (SEP) rubber, styrene-butadiene-styrene (SBS) rubber, and styrene-butadiene (SB) rubber.

In a specific embodiment of the present invention, the additive (G) may comprise at least one selected from the group consisting of processing aids, lubricants, stabilizers, flame retardant aids, antioxidants, weathering stabilizers, mold release agents, neutralizers, anti-blocking agents, fillers, anti-static agents, slip agents, additional nucleating agents, flame retardants, pigments, and dyes.

According to another embodiment of the present invention, there is provided a flame-retardant modified-poly(phenylene oxide) resin article molded from the flame-retardant modified-poly(phenylene oxide) resin composition.

In a specific embodiment of the present invention, the flame-retardant modified-poly(phenylene oxide) resin article may be used as a battery module housing for electric vehicles.

### Advantageous Effects of the Invention

The flame-retardant modified-poly(phenylene oxide) resin composition according to an embodiment of the present invention is capable of providing a flame-retardant modified-poly(phenylene oxide) resin article that has excellent deformation resistance and mechanical properties, along with enhanced product moldability and appearance quality. Accordingly, the flame-retardant modified-poly(phenylene oxide) resin article can be advantageously used as a battery module housing for electric vehicles.

### DETAILED DESCRIPTION

Hereinafter, the present invention will be described in more detail.

The flame-retardant modified-poly(phenylene oxide) resin composition according to an embodiment of the present invention comprises, based on the total weight of the composition, (A) 40 to 60% by weight of a poly(phenylene oxide) resin; (B) 10 to 30% by weight of a polystyrene-based resin; (C) 5 to 15% by weight of a flame retardant; (D) 2 to 8% by weight of a compatibilizer; (E) 5 to 15% by weight of a reinforcing agent; (F) 1 to 5% by weight of an impact modifier; and (G) 2 to 6% by weight of an additive.

### (A) Poly(Phenylene Oxide) Resin

The flame-retardant modified-poly(phenylene oxide) resin composition according to an embodiment of the present invention comprises a poly(phenylene oxide) resin (A).

In a specific embodiment of the present invention, the poly(phenylene oxide) resin (A) may comprise at least one selected from the group consisting of poly(2,6-dimethyl-1,4-phenylene)ether, poly(2,6-diethyl-1,4-phenylene)ether, poly(2,6-dipropyl-1,4-phenylene)ether, poly(2,6-dibutyl-1,4-phenylene)ether, poly(2,6-dirauryl-1,4-phenylene)ether, poly(2-methyl-6-ethyl-1,4-phenylene)ether, poly(2-methyl-6-propyl-1,4-phenylene)ether, poly(2-methyl-6-tolyl-1,4-phenylene)ether, poly(2-methyl-6-butyl-1,4-phenylene)ether, poly(2-ethyl-6-propyl-1,4-phenylene)ether, poly(2,6-diphenyl-1,4-phenylene)ether, poly(2,6-dimethoxy-1,4-phenylene)ether, poly(2,6-diethoxy-1,4-phenylene)ether, poly(2,3,6-trimethyl-1,4-phenylene)ether, copolymers of poly(2,6-dimethyl-1,4-phenylene)ether and poly(2,3,6-trimethyl-1,4-phenylene)ether, and copolymers of poly(2,6-dimethyl-1,4-phenylene)ether and poly(2,3,5,6-tetramethyl-1,4-phenylene)ether, but it is not particularly limited thereto.

In a preferred embodiment of the present invention, the poly(phenylene oxide) resin (A) may comprise a copolymer of poly(2,6-dimethyl-1,4-phenylene)ether and poly(2,3,6-trimethyl-1,4-phenylene)ether or poly(2,6-dimethyl-1,4-phenylene)ether.

In a more preferred embodiment of the present invention, the poly(phenylene oxide) resin (A) may comprise poly(2,6-dimethyl-1,4-phenylene)ether.

Although the degree of polymerization or molecular weight of the poly(phenylene oxide) resin (A) is not particularly limited, it may have an intrinsic viscosity of 0.3 to 0.6 dl/g when measured in a chloroform solvent at 25° C. in light of the thermal stability and workability of the flame-retardant modified-poly(phenylene oxide) resin composition. If the intrinsic viscosity is less than 0.3 dl/g, the molecular weight is low, which enhances the fluidity of the resin composition, whereas thermal resistance is deteriorated, and it may be difficult to secure sufficient mechanical properties. On the other hand, if the intrinsic viscosity exceeds 0.6 dl/g, there may be a disadvantage in that the fluidity of the resin composition decreases, which increases the injection pressure and temperature during injection molding, thereby increasing the amount of deformation of a molded article.

The poly(phenylene oxide) resin (A) may be used alone. Alternatively, two or more types thereof with different intrinsic viscosities may be mixed at an appropriate ratio to be used.

The flame-retardant modified-poly(phenylene oxide) resin composition according to an embodiment of the present invention comprises the poly(phenylene oxide) resin (A) in a content of 40 to 60% by weight based on the total weight of the composition. Preferably, the content of the poly(phenylene oxide) resin (A) may be 50 to 60% by weight based on the total weight of the composition. If the content of the poly(phenylene oxide) resin (A) is less than 40% by weight, the mechanical properties and thermal resistance of a molded article may be deteriorated. If this content exceeds 60% by weight, the processability of the resin composition may be deteriorated.

### (B) Polystyrene-Based Resin

The flame-retardant modified-poly(phenylene oxide) resin composition according to an embodiment of the present invention comprises a polystyrene-based resin (B). The polystyrene-based resin (B) has excellent miscibility (compoundability or compatibility) with the poly(phenylene oxide) resin (A) and can serve to enhance processability by lowering the processing temperature of the resin composition.

In a specific embodiment of the present invention, the polystyrene-based resin (B) may comprise at least one selected from the group consisting of a high-impact polystyrene resin (HIPS resin), an acrylonitrile-butadiene-styrene resin (ABS resin), an acrylonitrile-ethylene-propylene rubber-styrene resin (AES resin), and an acrylonitrile-acrylate-styrene resin (AAS resin), but it is not particularly limited thereto.

In a preferred embodiment of the present invention, the polystyrene-based resin (B) may comprise a high-impact polystyrene resin (HIPS resin).

The flame-retardant modified-poly(phenylene oxide) resin composition according to an embodiment of the present invention comprises the polystyrene-based resin (B) in a content of 10 to 30% by weight based on the total weight of the composition. If the content of the polystyrene resin (B) is less than 10% by weight, the processability of the resin composition and the impact resistance and chemical resistance of a molded article may be deteriorated. On the other hand, if this content exceeds 30% by weight, the thermal resistance and mechanical properties of a molded article may be deteriorated.

### (C) Flame Retardant

The flame-retardant modified-poly(phenylene oxide) resin composition according to an embodiment of the present invention comprises a flame retardant (C).

In a specific embodiment of the present invention, the flame retardant (C) is a phosphorus-based flame retardant and may comprise at least one selected from the group consisting of triphenylphosphate (TPP), bisphenol A bis(diphenylphosphate) (BDP), and aluminum diethylphosphinate (ADP), but it is not particularly limited thereto.

The flame-retardant modified-poly(phenylene oxide) resin composition according to an embodiment of the present invention comprises the flame retardant (C) in a content of 5 to 15% by weight based on the total weight of the composition. If the content of the flame retardant (C) is less than 5% by weight, sufficient flame retardant effect may not be obtained. If this content exceeds 15% by weight, the flame retardancy of a molded article increases, whereas the flowability of the resin may excessively increase, thermal resistance, mechanical rigidity, and impact strength may be deteriorated, and gas may be generated on the exterior of an article during injection, which may cause deterioration in the exterior quality.

### (D) Compatibilizer

The flame-retardant modified-poly(phenylene oxide) resin composition according to an embodiment of the present invention comprises a compatibilizer (D). The compatibilizer (D) increases the compatibility of the poly(phenylene oxide) resin with other polymer resins, an impact modifier, an inorganic filler, or the like and increases the chemical bonding force at the interface, thereby serving to enhance the deformation resistance, mechanical properties, impact strength, and heat distortion temperature of the modified-poly(phenylene oxide) resin composition.

In a specific embodiment of the present invention, the compatibilizer (D) may comprise a modified poly(phenylene oxide) resin grafted with maleic anhydride prepared through a twin-screw extruder by the reaction and extrusion of a poly(phenylene oxide) resin and maleic anhydride.

The modified poly(phenylene oxide) resin grafted with maleic anhydride may be prepared by the reaction and extrusion of a poly(phenylene oxide) resin and maleic anhydride, optionally in the presence of dicumyl peroxide. In such an event, since maleic anhydride and dicumyl peroxide have very low decomposition temperatures, it is preferable to use a polystyrene resin as a processing aid. In addition, it is preferable to use a small amount of an antioxidant to remove the activity of unreacted dicumyl peroxide remaining in the modified poly(phenylene oxide) resin grafted with maleic anhydride.

The content of each component for the preparation of the modified poly(phenylene oxide) grafted with maleic anhydride is as follows: 80 to 90% by weight of a poly(phenylene oxide) resin; 10 to 30% by weight of a polystyrene resin; 1 to 5% by weight of maleic anhydride; 0 to 2% by weight of dicumyl peroxide; and 0.1 to 0.3% by weight of an antioxidant.

The flame-retardant modified-poly(phenylene oxide) resin composition according to an embodiment of the present invention comprises the compatibilizer (D) in a content of 2 to 8% by weight based on the total weight of the composition. If the content of the compatibilizer (D) is less than 2% by weight, the tensile strength, flexural strength, and flexural modulus of a molded article may be deteriorated. If this content exceeds 8% by weight, the mechanical properties of a molded article are no longer enhanced, while the melt viscosity of the resin composition increases and fluidity decreases, which may deteriorate moldability.

### (E) Reinforcing Agent

The flame-retardant modified-poly(phenylene oxide) resin composition according to an embodiment of the present invention comprises a reinforcing agent (E).

In a specific embodiment of the present invention, the reinforcing agent (E) may comprise at least one selected from the group consisting of silane-coated glass fiber and silane-coated glass beads, but it is not particularly limited thereto.

The size of the glass fiber is not particularly limited; however, it preferably has an average length of 1 to 10 mm and an average diameter of 5 to 15 μm. The size of the glass beads is not particularly limited as well; however, they preferably have an average diameter of 15 to 80 μm, preferably, 15 to 30 μm.

The flame-retardant modified-poly(phenylene oxide) resin composition according to an embodiment of the present invention comprises the reinforcing agent (E) in a content of 5 to 15% by weight based on the total weight of the composition. If the content of the reinforcing agent is within the above range, the rigidity of a molded article can be enhanced without impairing the unique characteristics of the modified-poly(phenylene oxide) resin.

### (F) Impact Modifier

The flame-retardant modified-poly(phenylene oxide) resin composition according to an embodiment of the present invention comprises an impact modifier (F).

In a specific embodiment of the present invention, the impact modifier (F) may comprise at least one selected from the group consisting of styrene-ethylene-butadiene-styrene (SEBS) rubber, styrene-ethylene-propylene-styrene (SEPS) rubber, styrene-ethylene-propylene (SEP) rubber, styrene-butadiene-styrene (SBS) rubber, and styrene-butadiene (SB) rubber, but it is not particularly limited thereto.

The content of styrene in the impact modifier (F) may be 30 to 32% by weight. If the styrene content exceeds 32% by weight, mechanical strength and heat distortion temperature increase, whereas there may be a problem of increased processing pressure during extrusion and decreased impact resistance of a molded article. If the styrene content is less than 30% by weight, the processing pressure may be lowered, whereas the mechanical strength of a molded article may be significantly reduced.

The flame-retardant modified-poly(phenylene oxide) resin composition according to an embodiment of the present invention comprises the impact modifier (F) in a content of 1 to 5% by weight based on the total weight of the composition. If the content of the impact modifier (F) is less than 1% by weight, the impact resistance characteristics of a molded article may be insufficient. If this content exceeds 5% by weight, the thermal resistance and mechanical properties of a molded article may be deteriorated.

### (G) Additive

The flame-retardant modified-poly(phenylene oxide) resin composition according to an embodiment of the present invention comprises an additive (G).

In a specific embodiment of the present invention, the additive (G) may comprise at least one selected from the group consisting of processing aids, lubricants, stabilizers, flame retardant aids, antioxidants, weathering stabilizers, mold release agents, neutralizers, anti-blocking agents, fillers, anti-static agents, slip agents, nucleating agents, additional flame retardants, pigments, and dyes, but it is not particularly limited thereto.

In a specific embodiment of the present invention, the flame-retardant modified-poly(phenylene oxide) resin composition may further comprise an antioxidant to increase the thermal stability thereof. The antioxidant may be a phenol-based antioxidant or a phosphorus-based antioxidant. Specifically, the flame-retardant modified-poly(phenylene oxide) resin composition may comprise at least one antioxidant selected from the group consisting of pentaerythritol tetrakis(3-(3,5-di-t-butyl-4-hydroxyphenyl) propionate), 1,3,5-trimethyl-2,4,6-tris(3,5-di-t-butyl-4-hydroxybenzyl)benzene, and tris(2,4-di-t-butylphenyl)phosphite in an amount of 0.05 to 0.3% by weight based on the total weight of the composition. If the content of the antioxidant is less than 0.05% by weight, it is difficult to secure long-term thermal stability. Meanwhile, if the content of the antioxidant exceeds 0.3% by weight, the thermal stability would not be further improved, and the economic efficiency of the product may be reduced, which is not preferable.

According to another embodiment of the present invention, there is provided a flame-retardant modified-poly(phenylene oxide) resin article molded from the flame-retardant modified-poly(phenylene oxide) resin composition.

There is no particular limitation to the method of preparing a molded article from the flame-retardant modified-poly(phenylene oxide) resin composition according to an embodiment of the present invention. Any method known in the technical field of the present invention may be used. For example, the flame-retardant modified-poly(phenylene oxide) resin composition according to an embodiment of the present invention may be molded by a conventional method such as injection molding, extrusion molding, casting molding, or the like to prepare a flame-retardant modified-poly(phenylene oxide) resin article. Preferably, the flame-retardant modified-poly(phenylene oxide) resin composition may be injection molded to prepare a molded article.

The flame-retardant modified-poly(phenylene oxide) resin article according to an embodiment of the present invention may be used as a battery module housing for electric vehicles, an ESS battery module housing, or the like.

### EXAMPLE

Hereinafter, the present invention is explained in detail by the following examples. However, the following examples are intended to further illustrate the present invention. The scope of the present invention is not limited thereto only.

### Examples 1 and 2 and Comparative Examples 1 and 2

The resins and compounds below were used in the amounts shown in Table 1.

A poly(phenylene oxide) resin, a polystyrene resin, a flame retardant, and additives were premixed using a Henschel mixer and fed to the main feeder of a twin-screw extruder (75 mm, L/D 1:44), and the reinforcing agent was fed to the side feeder. The extrudate was pelletized to prepare flame retardant resin composition pellets. Subsequently, each test specimen was made from the resin composition pellets obtained above using an Ankel 180-ton injection machine, and mechanical properties were measured.
A1: poly(2,6-dimethyl-1,4-phenylene)ether (Bluestar, LXR040, intrinsic viscosity 0.4)
B1: high-impact polystyrene resin (HIPS) (Ineos Styrolution PS, HIPS 576H; styrene content 96% by weight, Vicat softening point 90° C.)
C1: flame retardant (bisphenol A bis(diphenylphosphate); Adeka, FP-600)
D1: modified polyphenylene oxide resin grafted with maleic anhydride (Hanwha TotalEnergies, QX12)
E1: reinforcing agent (KCC, CS915; avg. diameter 9-11 μm, avg. length 4 mm, aminosilane-treated glass fiber)
E2: reinforcing agent (Microperl, glass beads, D50 15-30 μm, D90 30-80 μm)
F1: impact modifier (LCY, SEBS 9550: styrene content 30-32% by weight)
G1: processing aid (Hanwha TotalEnergies, R901U; linear low-density polyethylene (LLDPE), melt index 6)
G2: lubricant (Clariant, OP_FL, dropping point 96-102° C., saponification value 102-122 mg KOH/g)
G3: primary stabilizer (BASF, Irganox 1098, melting point 156-161° C., 1% weight loss 280° ° C., 10% weight loss 340° C.)
G4: secondary stabilizer (Adeka, Stab PEP-36, melting point 234-240° C.)
G5: flame retardant aid (PJ Chemtek Co. Ltd., KS-1 (zinc oxide), avg. particle size 0.6-1 μm)
G6: flame retardant aid (Yuil Chemi Tech Co., Ltd., D50 (zinc borate), avg. particle size 3 μm)
G7: Black M/B (SM Industry, SB9800SB, nigrosine content 37-43%)

TABLE 1

| | Ex. 1 | Ex. 2 | C. Ex. 1 | C. Ex. 2 |
|---|---|---|---|---|
| A1 | 51.3 | 51.3 | 53.3 | 53.3 |
| B1 | 17.5 | 17.5 | 18.5 | 18.5 |
| C1 | 11 | 11 | 11 | 11 |
| D1 | 3 | 3 | — | — |
| E1 | — | 5 | — | 5 |
| E2 | 10 | 5 | 10 | 5 |
| F1 | 3 | 3 | 3 | 3 |
| G1 | 2 | 2 | 2 | 2 |
| G2 | 0.3 | 0.3 | 0.3 | 0.3 |
| G3 | 0.1 | 0.1 | 0.1 | 0.1 |
| G4 | 0.1 | 0.1 | 0.1 | 0.1 |
| G5 | 0.1 | 0.1 | 0.1 | 0.1 |
| G6 | 0.1 | 0.1 | 0.1 | 0.1 |
| G7 | 1.5 | 1.5 | 1.5 | 1.5 |
| Total (%) | 100 | 100 | 100 | 100 |

### Test Example

The flame-retardant modified-poly(phenylene oxide) resin compositions and the specimens prepared therefrom in the Examples and Comparative Examples were each tested by the following methods.

### (1) Specific Gravity

It was measured in accordance with ISO 1183.

### (2) Melt Index

It was measured at 285° C. under a load of 5 kg in accordance with ASTM D1238.

### (3) Tensile Strength and Elongation

They were measured in accordance with ISO R527. The specimen was prepared according to TYPE A, and the test speed was 50 mm/minute.

### (4) Flexural Modulus and Flexural Strength

They were measured in accordance with ASTM R178. The specimen had a size of 80 mm×10 mm×4.0 mm, the span length was 60 mm, and the test speed was 2 mm/minute.

### (5) Charpy Impact Strength

It was measured in accordance with ISO R179. The specimen had a size of 80 mm×10 mm×4.0 mm and was notched.

### (6) Heat Deflection Temperature

It was measured in accordance with ISO R75. The specimen had a size of 80 mm×10 mm×4.0 mm, and the stress loads were 0.45 MPa and 1.8 MPa.

### (7) Molding Shrinkage

The molding shrinkage was measured according to ISO 294-3/4. A specimen with a size of 101.6 mm×152 mm×3.2 mm was prepared using an injection molding machine. The specimen in the direction of resin flow (mold direction (MD)) and the direction perpendicular to the resin flow (transverse direction (TD)) was left for 48 hours at room temperature (23° C., relative humidity 50%), and the initial dimensions and the dimensions indicated on the surface of the specimen left for 48 hours after injection were measured. The shrinkage of the specimen after injection was obtained from Equation 1 below.

Shrinkage=(initial dimensions of specimen−dimensions of specimen after 48 hours)/initial dimensions of specimen×1,000 [Equation 1]

TABLE 2

| | Unit | Ex. 1 | Ex. 2 | C. Ex. 1 | C. Ex. 2 |
|---|---|---|---|---|---|
| Appearance quality | — | Normal | Good | Normal | Good |
| Melt index | g/10 min. | 13 | 18 | 26 | 34 |
| (MI, 285° C.; 5 kg) | | | | | |
| Specific gravity | — | 1.15 | 1.15 | 1.15 | 1.15 |
| Tensile strength (yield) | MPa | 86 | 72 | 78 | 62 |
| Elongation (break) | % | 3 | 4 | 2 | 3 |
| Flexural strength | MPa | 117 | 110 | 110 | 102 |
| Flexural modulus | MPa | 3,480 | 3,145 | 3,390 | 2,988 |
| Charpy impact strength | J/m | 131 | 92 | 117 | 64 |
| (23° C.) | | | | | |
| Charpy impact strength | J/m | 83 | 64 | 71 | 55 |
| (−30° C.) | | | | | |
| Heat deflection temperature | ° C. | 134 | 127 | 129 | 124 |
| (0.45 MPa) | | | | | |
| Heat deflection temperature | ° C. | 123 | 118 | 119 | 113 |
| (1.8 MPa) | | | | | |
| Molding shrinkage | — | 6 | 6 | 6 | 6 |
| (MD, 1/1,000) | | | | | |
| Molding shrinkage | — | 4 | 2 | 4 | 2 |
| (TD, 1/1,000) | | | | | |

As can be seen from Tables 1 and 2 above, the molded articles prepared from the flame-retardant modified-poly(phenylene oxide) resin composition of the Examples within the scope of the present invention were all excellent in mechanical properties, thermal resistance characteristics, and mold shrinkage.

In contrast, in Comparative Example 1, in which no compatibilizer was used, mechanical properties including tensile strength and heat distortion temperature were deteriorated as compared with Example 1. In Comparative Example 2, in which no compatibilizer was used, mechanical properties including tensile strength and heat distortion temperature were deteriorated as compared with Example 2.

The flame-retardant modified-poly(phenylene oxide) resin composition of the Examples, falling within the scope of the present invention, is capable of providing a flame-retardant modified-poly(phenylene oxide) resin article that has excellent deformation resistance and mechanical properties, along with enhanced product moldability and appearance quality. Accordingly, the flame-retardant modified-poly(phenylene oxide) resin article can be advantageously used as a battery module housing for electric vehicles.

What is claimed is:

1. A flame-retardant modified-poly(phenylene oxide) resin composition, which comprises, based on the total weight of the composition, (A) 40 to 60% by weight of a poly(phenylene oxide) resin; (B) 10 to 30% by weight of a polystyrene-based resin; (C) 5 to 15% by weight of a flame retardant; (D) 2 to 8% by weight of a compatibilizer; (E) 5 to 15% by weight of a reinforcing agent; (F) 1 to 5% by weight of an impact modifier; and (G) 2 to 6% by weight of an additive.

2. The flame-retardant modified-poly(phenylene oxide) resin composition of claim 1, wherein the poly(phenylene oxide) resin (A) comprises at least one selected from the group consisting of poly(2,6-dimethyl-1,4-phenylene)ether, poly(2,6-diethyl-1,4-phenylene)ether, poly(2,6-dipropyl-1,4-phenylene)ether, poly(2,6-dibutyl-1,4-phenylene)ether, poly(2,6-dirauryl-1,4-phenylene)ether, poly(2-methyl-6-ethyl-1,4-phenylene)ether, poly(2-methyl-6-propyl-1,4-phenylene)ether, poly(2-methyl-6-tolyl-1,4-phenylene)ether, poly(2-methyl-6-butyl-1,4-phenylene)ether, poly(2-ethyl-6-propyl-1,4-phenylene)ether, poly(2,6-diphenyl-1,4-phenylene)ether, poly(2,6-dimethoxy-1,4-phenylene)ether, poly(2,6-diethoxy-1,4-phenylene)ether, poly(2,3,6-trimethyl-1,4-phenylene)ether, copolymers of poly(2,6-dimethyl-1,4-phenylene)ether and poly(2,3,6-trimethyl-1,4-phenylene)ether, and copolymers of poly(2,6-dimethyl-1,4-phenylene)ether and poly(2,3,5,6-tetramethyl-1,4-phenylene)ether.

3. The flame-retardant modified-poly(phenylene oxide) resin composition of claim 1, wherein the poly(phenylene oxide) resin (A) comprises poly(2,6-dimethyl-1,4-phenylene)ether.

4. The flame-retardant modified-poly(phenylene oxide) resin composition of claim 1, wherein the poly(phenylene oxide) resin (A) has an intrinsic viscosity of 0.3 to 0.6 dl/g when measured in a chloroform solvent at 25° C.

5. The flame-retardant modified-poly(phenylene oxide) resin composition of claim 1, wherein the polystyrene-based resin (B) comprises at least one selected from the group consisting of a high-impact polystyrene resin (HIPS resin), an acrylonitrile-butadiene-styrene resin (ABS resin), an acrylonitrile-ethylene-propylene rubber-styrene resin (AES resin), and an acrylonitrile-acrylate-styrene resin (AAS resin).

6. The flame-retardant modified-poly(phenylene oxide) resin composition of claim 5, wherein the polystyrene-based resin (B) comprises a high-impact polystyrene resin.

7. The flame-retardant modified-poly(phenylene oxide) resin composition of claim 1, wherein the flame retardant (C) is a phosphorus-based flame retardant and comprises at least one selected from the group consisting of triphenylphosphate (TPP), bisphenol A bis(diphenylphosphate) (BDP), and aluminum diethylphosphinate (ADP).

8. The flame-retardant modified-poly(phenylene oxide) resin composition of claim 1, wherein the compatibilizer (D) comprises a modified poly(phenylene oxide) resin grafted with maleic anhydride prepared by the reaction and extrusion of a poly(phenylene oxide) resin and maleic anhydride.

9. The flame-retardant modified-poly(phenylene oxide) resin composition of claim 1, wherein the reinforcing agent (E) comprises at least one selected from the group consisting of silane-coated glass fiber and silane-coated glass beads.

10. The flame-retardant modified-poly(phenylene oxide) resin composition of claim 1, wherein the impact modifier (F) comprises at least one selected from the group consisting of styrene-ethylene-butadiene-styrene (SEBS) rubber, styrene-ethylene-propylene-styrene (SEPS) rubber, styrene-ethylene-propylene (SEP) rubber, styrene-butadiene-styrene (SBS) rubber, and styrene-butadiene (SB) rubber.

11. The flame-retardant modified-poly(phenylene oxide) resin composition of claim 1, wherein the additive (G) comprises at least one selected from the group consisting of processing aids, lubricants, stabilizers, flame retardant aids, antioxidants, weathering stabilizers, mold release agents, neutralizers, anti-blocking agents, fillers, anti-static agents, slip agents, nucleating agents, additional flame retardants, pigments, and dyes.

12. A flame-retardant modified-poly(phenylene oxide) resin article, which is molded from the flame-retardant modified-poly(phenylene oxide) resin composition according to claim 1.

13. The flame-retardant modified-poly(phenylene oxide) resin article of claim 12, which is used as a battery module housing for electric vehicles.
